(19) United States
(12) Patent Application Publication
(10) Pub. No.: US 2018/0012305 A1
(43) Pub. Date: Jan. 11, 2018

(54) ESTIMATION OF MARKET RISK

(71) Applicant: Sara Wojnar, Delray Beach, FL (US)

(72) Inventor: Sara Wojnar, Delray Beach, FL (US)

(21) Appl. No.: 15/644,076

(22) Filed: Jul. 7, 2017

Related U.S. Application Data
(60) Provisional application No. 62/359,500, filed on Jul. 7, 2016.

(51) Int. Cl. G06Q 40/06; G06Q 40/04

(52) U.S. Cl. CPC G06Q 40/06; G06Q 40/04

(57) ABSTRACT

A method of determining the return of a securities portfolio defined by returns from a portfolio's excess returns and returns from exposure to the market's excess returns, or changes in valuation, by calculating tangible returns and intangible returns, and applying the tangible returns and intangible returns to models used in determining asset allocations. A computer program stored on non-transitory media encoding instructions for executing a method that determines the return of a securities portfolio defined by returns from a portfolio's excess returns and returns from exposure to the market's excess returns, or changes in valuation, by calculating tangible returns and intangible returns, and applying the tangible returns and intangible returns to models used in determining asset allocation.

### BACKGROUND OF THE INVENTION

### 1. Technical Field

The present invention relates to securities investing. The present invention relates more specifically to the computation and use of portfolio returns.

### 2. Background Art

Portfolio returns, by intent, reflect the performance of securities within a market or a segment of a market. Sometimes returns are calculated in excess of the T-bill (an example would be excess returns). Sometimes financial modeling is used to forecast future returns (an example would be expected returns).

Returns are generally all-inclusive of the performance of the securities within their defined portfolio. The nature of calculating performance means that if the price of a security rises, it is accorded a gain, or positive performance. Alternatively, a security whose price declines is accorded a loss, or negative performance.

Conventionally, there are broad methods to compute portfolio returns. One conventional calculation is expected return, wherein to determine the expected return on a portfolio, the weighted average expected return of the assets that comprise the portfolio is taken. Expected return is calculated by using the following formula:

E(R) of a portfolio=w₁R₁+w₂R₂+ . . . +wₙRₙ (Eq. 1).

For example, a portfolio holds two mutual funds: mutual fund A invests in stocks and mutual fund B invests in bonds. If one expects fund A to return 10% and fund B to return 6%, and the allocation is 50% to each asset class, the following formula results: Expected Return=(0.1)*(0.5)+(0.6)*(0.5)=0.08 or 8%.

Expected returns do not guarantee a rate of return and rely on presumptions of future returns. However, expected returns can be used to forecast the future value of a portfolio, and can act as a guide from which to compare actual returns.

Another conventional method is excess returns, wherein excess returns are the returns from a portfolio that exceed the risk-free rate, such as a certificate of deposit or a government-issued bond. Excess returns can also be applied to returns that exceed a specific benchmark or index. Excess returns can be expressed in the following formula:

Excess Returns=Return−Risk-free Rate (Eq. 2).

For example, if the current risk-free rate is 1.5% and the portfolio generated a return of 8%, the following formula results: Excess Return=8%−1.5%=6.5%.

Excess returns is widely used as a measure of value added by the portfolio or the portfolio manager's ability to outperform the market. Excess returns can also be referred to as alpha, after being adjusted for the risk assessed, known as beta. Although widely used, excess returns can be difficult to generate on a consistent basis over the long-term.

Another neutral conventional method is actual returns, which is the actual gain or loss from a portfolio. Actual returns (ex-post) are what investors actually receive from their investments, as opposed to an estimation of the same (ex-ante). Actual returns can be expressed as expected returns plus firm-specific and economy-wide news and events. The discrepancy between actual return and expected return is due to systematic risk, and generally can be assessed after the fact.

This can create a situation where actual returns are compared to expected returns after the fact, where excess returns are hard to generate on a consistent basis over the long-term, and where expected returns rely on presumptions to calculate likely returns. This can lead to increased turnover in a portfolio that may have had to absorb repeatedly increased allocations to stocks that have risen and reduced allocations to stocks that have declined.

Therefore, there remains a need for a method of calculating returns that more accurately reflects returns from a portfolio's excess returns and returns from fluctuations in valuation.

### SUMMARY OF THE INVENTION

The present invention provides for a method of determining the return of a securities portfolio defined by a portfolio's excess returns and the market's excess returns by calculating tangible returns and intangible returns, and applying the tangible returns and intangible returns to models used in determining asset allocations.

The present invention provides for a computer program stored on non-transitory media encoding instructions for executing a method that determines the return of a securities portfolio defined by a portfolio's excess returns and the market's excess returns by calculating tangible returns and intangible returns, and applying the tangible returns and intangible returns to models used in determining asset allocations.

### DESCRIPTION OF THE DRAWINGS

Other advantages of the present invention are readily appreciated as the same becomes better understood by reference to the following detailed description when considered in connection with the accompanying drawings wherein:

FIG. 1 is a flow chart of the method of the present invention.

### DETAILED DESCRIPTION OF THE INVENTION

The present invention relates generally to methods of determining the return of a securities portfolio defined by a portfolio's excess returns and returns from changes in valuation with more accuracy than previous methods by including calculations for two components of returns (tangible returns and intangible returns) and can be used as a new financial model for portfolio performance.

As used herein, a “securities portfolio” includes investments in the form of a group of assets and reflects the returns of securities in an entire market or a segment of a market.

As used herein, “returns” are gains or losses on investments or stocks and can include changes in value as well as interest or dividends. Returns are generally all-inclusive of the securities within the portfolio. In most cases returns can include each security in the portfolio. Conventionally, returns are based on the overall performance of a securities portfolio or index. Returns can include tangible returns and intangible returns, further described below.

As used herein, “tangible returns” refers to the portion of returns less a change in value, computed by subtracting the intangible portion of returns from a portfolio's excess returns, as represented by the y-intercept, also referred to as alpha (α), according to regression equation Y=α+β*t+ε. Tangible returns can be interpreted as the portion of a portfolio's excess returns less changes in value, and can be denoted as the value that Y takes when t is zero. The tangible returns can be said to represent returns derived from portfolio-specific sources in this instance.

As used herein, “intangible returns” refers to changes in value, computed as the average of coefficient estimates of the market's excess returns, as represented by the slope, also referred to as beta (β), according to regression equation Y=α+β*t+ε. Intangible returns can be interpreted as a change in value, and can be denoted as the change in Y given a change in t. The intangible returns can be expressed as changes in value from exposure to the market's excess returns.

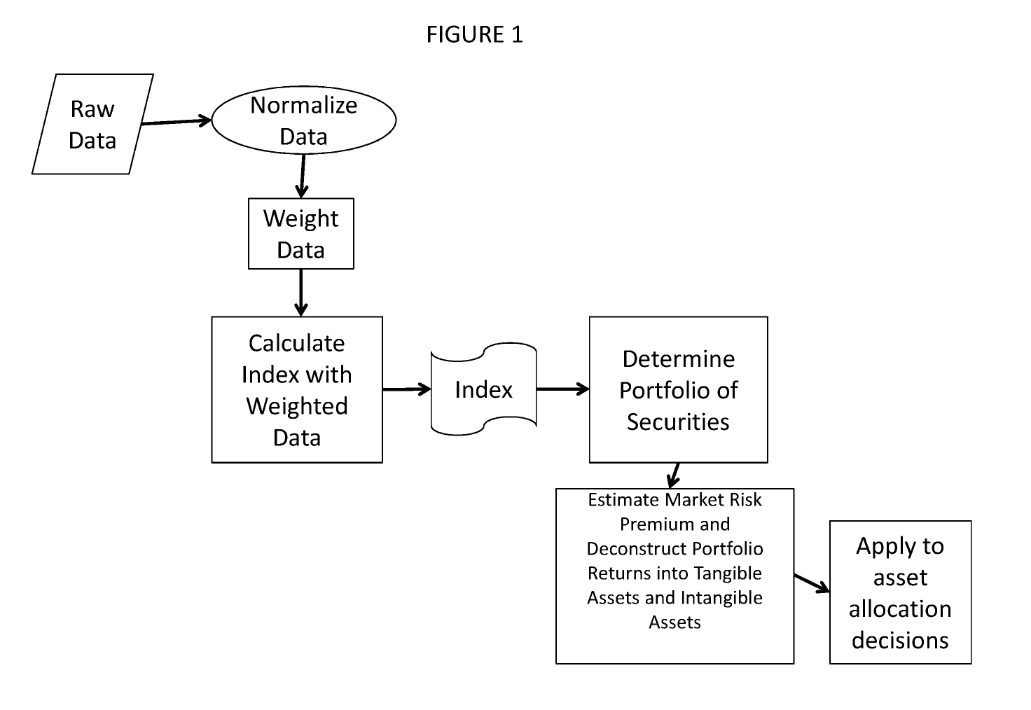

The method is generally performed by the steps shown in FIG. 1. Raw data is collected and then normalized. The data is weighted. An index is calculated with the weighted data, resulting in an index that creates a basis for a portfolio of securities. The portfolio of securities is determined. The portfolio returns are analyzed to estimate the market risk premium (beta) and then deconstructed into tangible assets and intangible assets, and applied to asset allocation decisions. Depending on application to asset allocation decisions, the securities can then be traded.

The raw data are parameters that represent drivers of business performance covering sales, operating efficiencies, and assets. The data can be found on standard financial statements and can be obtained from various subscription sources including Bloomberg, S&P Capital IQ, Thomson Reuters, Compustat, WRDS, CRSP, CCM, as well as standard financial statements issued by publicly traded companies. The raw data is collected from the universe of public companies.

The raw data can be normalized by organizing the data by attributes to reduce and eliminate redundant data and improve data integrity.

After the raw data is normalized, the top 1000 companies for each driver of business performance are indexed by their relative metric weight. A combined equally-weighted composite index is calculated and used as a portfolio of securities to be examined. The index of securities can be sub-divided by sector, country, region, asset class, etc. An example of a fundamentally-weighted index is described in U.S. Pat. No. 7,620,577 to Arnott.

The portfolio of securities is determined next. The index can be used as the basis for a portfolio of securities. The portfolios can also be categorized based on sector, country, region, asset class, etc. For example, the portfolio can include the top 1000 companies.

The portfolio returns are then determined. The analysis of portfolio returns entails a cross-sectional regression analysis to estimate the premium rewarded for exposure to market risk. In other words, the portion of returns that comes from fluctuations in value is estimated. Two regressions are conducted. The first regression uses the portfolio's excess returns regressed against the market's excess returns. The output is then regressed against the portfolio's excess returns in the second regression. The coefficients are then averaged to estimate the factor premium for the y-intercept and slope. The y-intercept is denoted as alpha (α) and the slope is denoted as beta (β).

The portfolio's excess returns are deconstructed into tangible returns and intangible returns using the following equation:

Excess Returns=Tangible Returns+Intangible Returns (Eq. 3).

Intangible Returns can be expressed as the portion of return that comes from changes in valuation. It is defined as the fluctuations in value over time, computed as the average of the market risk coefficient β according to regression equation:

Y=α+β*t+ε (Eq. 4)

where t is measured in years and ε is standard error (and can equate to one standard deviation from the distribution), Y is the vertical axis or valuation, and α is the y-intercept or value that Y takes when t is zero.

By subtracting the market's excess returns (β) from the portfolio's excess returns, the Tangible Return is the remaining portion of return computed by:

Tangible Return=Excess Return−Intangible Return (Eq. 5).

Tangible Return can be interpreted as the return of a portfolio less changes in valuation.

Once the Tangible Returns and Intangible Returns have been determined, they can be applied in a financial model to determine asset allocation, future returns, or valuation. For example, Tangible Returns can be used as a valuation measure when applied to the securities market, and can then be used to assess likely future returns from securities and asset allocation decisions.

Advantages of separating portfolio returns into two components include optimized asset allocation and enhanced forecasting models. Asset allocation can be optimized by favoring investments in companies that generate returns from the portfolio's excess returns rather than returns that come from changes in value. This can also be used to determine if past returns are likely to be repeatable. In addition, future expectations and returns can also be assessed. Future expectations and returns from securities can be assessed using a model of expected returns. Examples of theoretical models include arbitrage pricing theory (APT), the capital asset pricing model (CAPM), and intertemporal CAPM (ICAPM). One skilled in the art can apply the data to these models.

The method of the present invention has several advantages over prior art methods, such as being able to take account of the portion of return that comes from changes in value. The use of two components of return allows the calculation of returns to better reflect the economic scale and future growth potential of securities within a portfolio. The use of two components of returns increases the quantity and quality of details for a computer model. As a model becomes more detailed, it becomes more powerful and the accuracy of forecasting future returns is improved significantly. The tangible portion of returns allows for calculation of returns less a change in value and offers an investor an alternative to improve upon portfolio risk characteristics. The portfolio returns based on two components also provide additional advantages including improved accuracy in forecasting future returns, outperformance, and lower portfolio volatility.

Traditionally, academia has created financial model computations. Academics typically focus on theoretically appropriate methods. An example includes the Capital Asset Pricing Model (CAPM). The present invention expands upon current concepts by integrating analysis of returns to create a new model that computes the difference between returns from changes in value (market's excess returns) and returns less changes in value (portfolio's excess returns).

A computer program (software) can be used to perform each of the steps of the method of the present invention, and can be stored on non-transitory media on any suitable computer. The computer program can also be in an application form (“app”) that can be used on any portable media device such as smart phones or tablets. The computer program can be in electronic communication with visual displays, any necessary communications equipment required for internet connections (wired or wireless), BLUETOOTH® connections, database subscriptions, and data analysis programs in order to run the program. The present invention also provides for a computer program encoding instructions for executing the method. Most generally, the computer program determines the return of a securities portfolio defined by returns from portfolio's excess returns and returns from changes in valuation by calculating tangible returns and intangible returns, and applies the tangible returns and intangible returns to models used in determining asset allocations.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A method of determining the return of a securities portfolio defined by returns from a portfolio's excess returns and returns from changes in valuation, including the steps of:
calculating tangible returns and intangible returns; and
applying the tangible returns and intangible returns to models used in determining asset allocations.

2. The method of claim 1, further including, before said calculating step, the steps of collecting raw data, normalizing raw data, weighting normalized data, calculating an index with weighted data, and determining a portfolio of securities.

3. The method of claim 1, wherein the raw data for portfolio construction include metrics of business performance covering sales, operating efficiencies, and tangible assets.

4. The method of claim 1, wherein said normalizing step is performed by minimizing redundancy in the raw data.

5. The method of claim 1, wherein said calculating an index step includes the steps of sorting the data by drivers of performance and indexing the data by relative metric weight.

6. The method of claim 1, wherein said determining a portfolio of securities step is performed by using the index as a basis for the portfolio of securities.

7. The method of claim 1, wherein said calculating tangible returns and intangible returns includes calculating a beta coefficient estimate and deconstructing the portfolio's excess returns into tangible returns and intangible returns.

8. The method of claim 7, wherein intangible returns are calculated from the beta (β) coefficient estimate according to the regression equation Y=α+β*t+ε, wherein where Y is valuation, t is measured in years, ε is standard error, α is the y-intercept, and β is the slope.

9. The method of claim 8, wherein tangible returns are calculated by the equation Tangible Return=Excess Return−Intangible Return.

10. The method of claim 1, further including the step of determining if past returns are repeatable.

11. The method of claim 1, wherein said applying step further includes the step of assessing future expectations and returns by using a model of expected returns.

12. A computer program stored on non-transitory media encoding instructions for executing a method that determines the return of a securities portfolio defined by returns from a portfolio's excess returns and returns from changes in valuation including the steps of:
calculating tangible returns and intangible returns; and
applying the tangible returns and intangible returns to models used in determining asset allocations.

13. The computer program of claim 12, further including, before said calculating step, the steps of collecting raw data, normalizing raw data, weighting normalized data, calculating an index with weighted data, and determining a portfolio of securities.

14. The computer program of claim 12, wherein the wherein the raw data for portfolio construction include metrics of business performance covering sales, operating efficiencies, and tangible assets.

15. The computer program of claim 12, wherein said normalizing step is performed by minimizing redundancy in the raw data.

16. The computer program of claim 12, wherein said calculating an index step includes the steps of sorting the data by drivers of performance and indexing the data by relative metric weight.

17. The computer program of claim 12, wherein said determining a portfolio of securities step is performed by using the index as a basis for the portfolio of securities.

18. The computer program of claim 12, wherein said calculating tangible returns and intangible returns includes calculating a beta coefficient estimate and deconstructing the portfolio's excess returns into tangible returns and intangible returns.

19. The computer program of claim 18, wherein intangible returns are calculated from the beta (β) coefficient estimate according to the regression equation Y=α+β*t+ε, wherein Y is the vertical axis or valuation, t is measured in years, ε is standard error, α is the y-intercept, and β is the slope.

20. The computer program of claim 19, wherein tangible returns are calculated by the equation Tangible Return=Excess Return−Intangible Return.

21. The computer program of claim 12, wherein said applying step further includes the step of determining asset allocation decisions.

22. The computer program of claim 12, further including the step of determining if past returns are repeatable.

23. The computer program of claim 12, wherein said applying step further includes the step of assessing future expectations and returns by using a model of expected returns.
